(19) United States
(12) Patent Application Publication
(10) Pub. No.: US 2011/0191663 A1
(43) Pub. Date: Aug. 4, 2011

(54) EFFICIENT PRESENTATION OF IMPORTANT PROFILE INFORMATION TO A PROFILE READER

(76) Inventors: Mark Magas, Glenview, IL (US); Amy Pearson, Glenview, IL (US)

(21) Appl. No.: 13/018,199

(22) Filed: Jan. 31, 2011

Related U.S. Application Data
(60) Provisional application No. 61/299,996, filed on Jan. 31, 2010.

(51) Int. Cl. G06F 17/00

(52) U.S. Cl. 715/202; 715/201

(57) ABSTRACT

The subject matter disclosed herein provides a streamlined view of an online resume, profile, or other computer-generated document representing an individual and to tailor it to a particular reader. The streamlining occurs through the use of tabs or other sectioned areas in the document so that the reader of the document can find important information about the individual more quickly. Information in the document may be prioritized according to rules set by the reader, the document owner, or pre-defined rules.

### CROSS-REFERENCE TO RELATED APPLICATION

The present patent application claims priority to U.S. Provisional Patent Application Serial No. 61/299,996, entitled “Efficient Presentation of Important Profile Information To A Profile Reader,” filed Jan. 31, 2010, and invented by Mark Magas and Amy Magas, the disclosure of which is incorporated by reference herein.

### BACKGROUND

It is commonly known that employers and recruiters spend an average of 10-20 seconds reviewing a resume. Candidates are encouraged to create a one-page resume because it is likely that the reviewer will not even make it to a second page. Online resumes are different in that there is no requirement for this type of resume to be one page. However, it still is necessary to catch the reviewer's interest in a very short amount of time. Traditionally, this has been difficult to do because for most of the last 10 years, resumes on job search sites have only been comprised of a few large text fields containing all of the resume information.

Recently, Visual CV (http://www.visualcv.com) developed a more visually appealing online resume which allows users to include images, videos, and documents, links to social networking sites, and references in an online resume. Although an important advance in online resumes, remaining problems associated with this online resume are as follows: 1) the resumes are not in a standard format and the user is allowed free reign to place images and other information wherever he/she chooses on the resume—therefore, a reviewer would not find the same type of information in the same locations from resume to resume—also, the resume becomes cluttered with random images and other documents with no particular order; 2) there is much wasted space in top portion of the resume—the most important informational location in the resume; 3) information between resumes is not comparable because the information (such as skills listings) that goes into each resume is not standardized; 4) data elements within current resumes cannot be linked to other data elements within the resumes—For example, a specific skill can't currently be linked to media files (i.e., if a resume owner was skilled at using AutoCAD and wanted to show an employer an example of an AutoCAD drawing he had drawn, next to the skill listing of “AutoCAD—10 years experience” could be a link to the AutoCAD file he drew); and 5) information cannot be tailored to the reviewers' search request, job posts, or preferences.

Thus, there remains significant room for improvement in online resume displays. Various technologies described herein relate to maximizing free space, minimizing scrolling, maximizing the quality of information initially displayed, displaying important information in best locations, linking information within the resume, and tailoring the information displayed in the online resume to the reviewer.

### SUMMARY

The subject matter disclosed herein is directed to an improved view of an online resume, profile, or other computer-generated document. The goal of the subject matter disclosed herein is to tailor an online document such as an html resume, a PDF resume, or a web profile to a particular reader. To accomplish this goal, information that is important to various users (i.e., readers) of the document is prioritized and displayed up-front, preferably in tabs (as shown in FIG. 3a), in the order of priority (“order priority”) to the particular reader. One having skill in the art will appreciate that such information may be located in other areas of the document such as a profile summary section (as that shown in FIG. 3b).

In the case of an online resume, an interactive tabbed resume 10 is disclosed as shown in FIG. 3a. The tabs 11-16 divide the resume into sections such as education, work experience, skills, media, references, and interests. Prioritized information 17-24 can be inserted into the section tabs to highlight important information contained in the resume that 1) may be important to the reader or 2) is important for the resume owner to show the reader. The prioritized information may also be shown in other locations in the online resume. The online resume may be a webpage (dynamic, depending on changes of the underlying content database) or a personalized electronic document such as an Adobe PDF or Microsoft Word file (static, unless automatically created based on changes to the underlying content database).

This same principle can be applied to any online document containing information that may be at varying importance to different users. For example, on a social networking site such as Facebook™, Linkedin™, or MySpace™, users store profiles that contain interests or qualifications that could be prioritized to a particular reader. This can also be used to tailor any information presented to a profile owner such as news on a news website or profile information on a social media website.

Information is prioritized by prioritization code (a “prioritizer”) in a priority order according to a combination of any or all of the following prioritization instructions: employer/reader preferences, search terms in a keyword search for a candidate/profile, a prioritization instruction from a resume/document owner; and matching data contained in an already stored online job post. If a change is made to any of the prioritization instructions, the affected online resumes or profiles will update. The prioritizer contains a prioritization algorithm including prioritization display rules that determine which prioritization instructions to follow and then display to the particular employer/reader.

A tabbed resume such as that shown in FIG. 3a, also allows for a measurement of time spent interacting with the resume. This data can be provided to the resume/document owner with additional resume/document analysis statistics.

Additional features and advantages of the various embodiments will be made apparent from the following detailed description of illustrated embodiments, which proceeds with reference to the accompanying drawings.

The technologies include the novel and non-obvious features, method steps, and acts alone and in various combinations and sub-combinations with one another as set forth in the claims below. The subject matter disclosed herein is not limited to a particular combination or sub-combination thereof. Technology from one or more of any of the examples can be incorporated into any of the other examples.

### BRIEF DESCRIPTION OF THE DRAWINGS

FIG. 1. Prior art resume (Monster.com)

FIG. 2. Prior art resume (VisualCV.com)

FIG. 3a . Exemplary online resume layout

FIG. 3b . Exemplary online resume layout

FIG. 4. Block diagram of an online resume prioritizer inputs and outputs

FIG. 5. Block diagram of an online profile prioritizer inputs and outputs

FIG. 6. Hardware architecture of preferred embodiment

FIG. 7a . Prior art search results

FIG. 7b . Prioritized data in search results

FIG. 8a . Prior art saved profile/notes

FIG. 8b . Prioritized data in saved profiles/notes

FIG. 9a . Example of an employer selecting general preferences

FIG. 9b .Example of a resume generated from selected general preferences shown in FIG. 9aspecific preferences, and resume owner setting

FIG. 10. Example of an online job post with terms selected by the preferred embodiment

### DETAILED DESCRIPTION

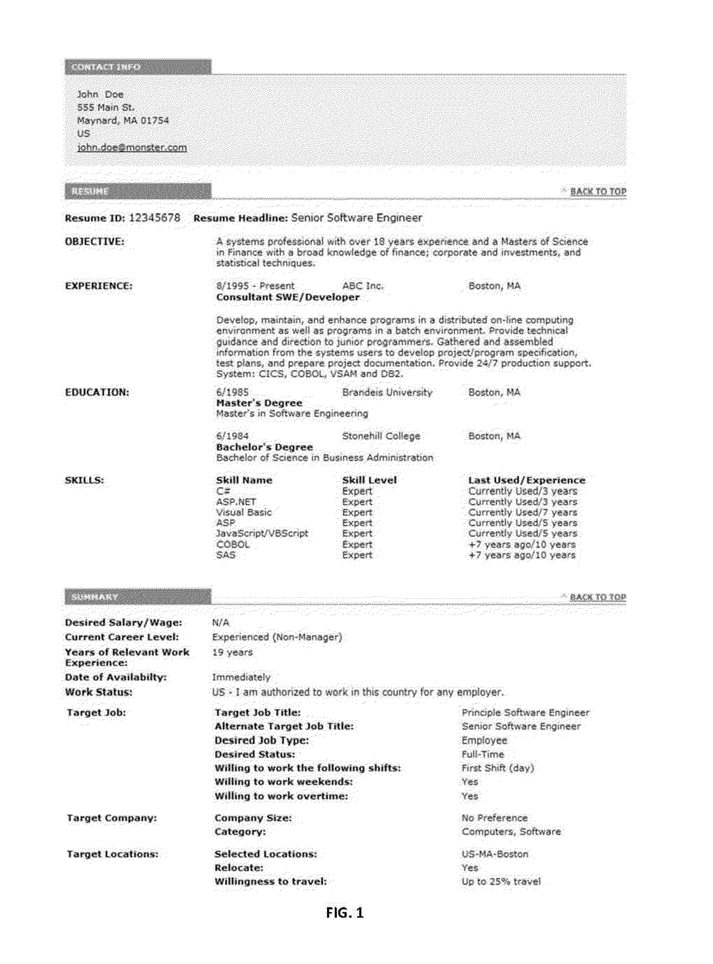

As described above, it is difficult to attract an employer's attention with current online resumes because they are either (a) only comprised of a few large text fields; or (b) poorly organized. FIG. 1 is an example of a text-based prior art resume. Although a standardized layout is used, such a resume is dry and does not lend itself to a one-page view unless minimal information is provided. The user cannot highlight important skills nor can the employer easily find important information about the candidate.

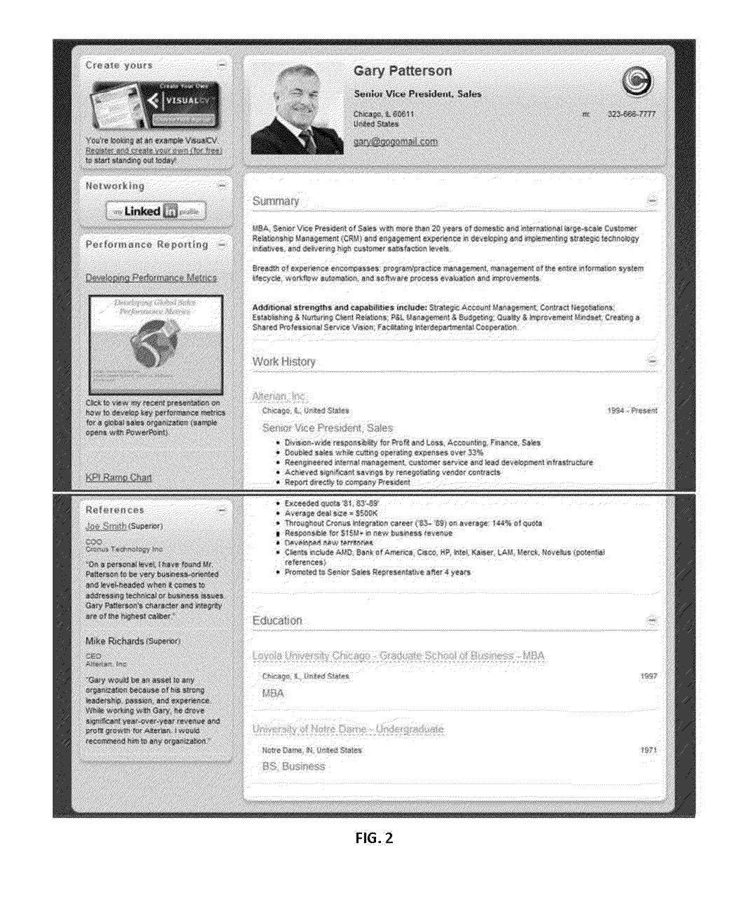

FIG. 2 is an example of a more graphical yet poorly organized prior art resume from VisualCV.com. Such a resume maximizes free space and allows a candidate to organize resume data including text, images, videos, documents, and references within the resume to optimize location of information that the candidate believes is important to the employer. Although visually more appealing than the text-based prior art resume shown in FIG. 1, this type of resume is not organized into a standardized format and does not take into account the needs/interests of the employer.

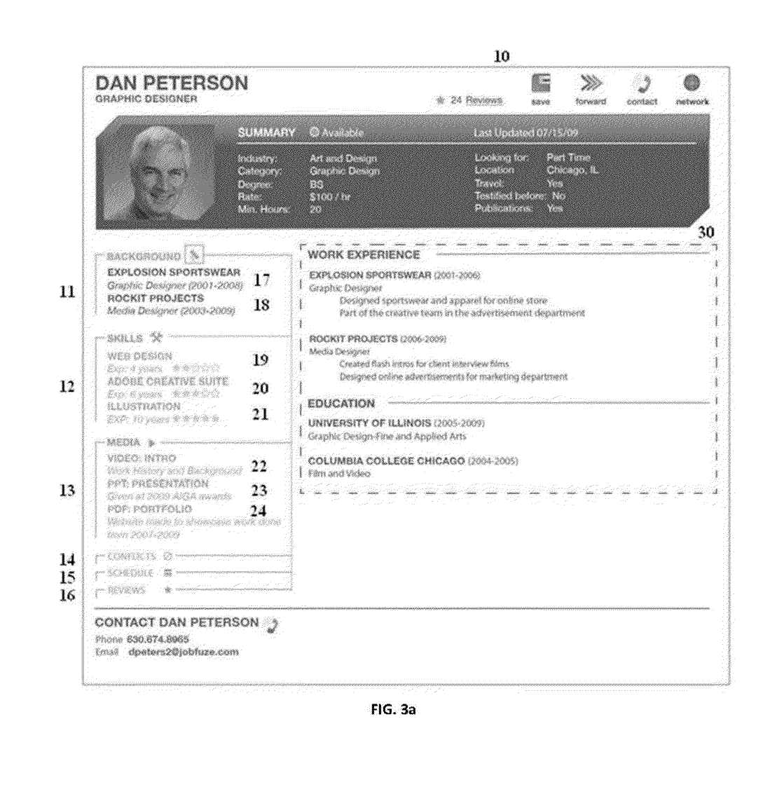

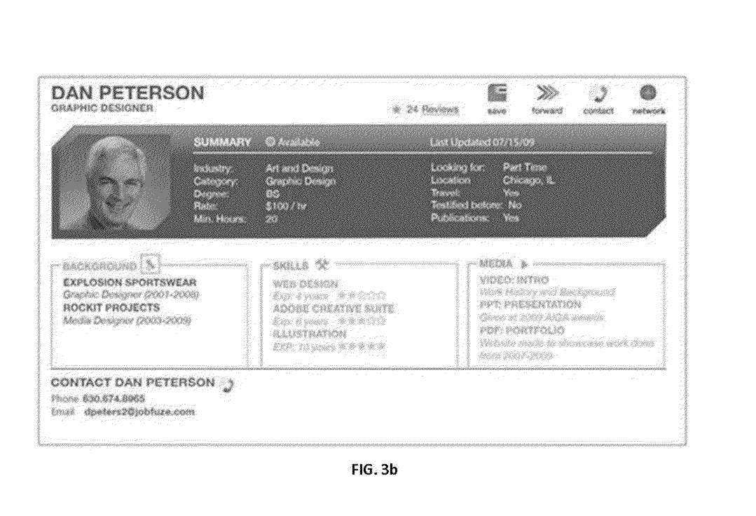

FIG. 3a shows an exemplary resume 10 for organizing resume data into an optimized format taking into account: (1) maximizing free space (blank space on the display) so as to fit as much data as possible onto a screen; (2) minimizing the need for an employer to scroll down onto a second page of the resume/screen height; (3) optimizing the quality of information displayed to the employer; and (4) optimizing placement of such quality information so as to emphasize candidate attributes of interest to employers.

An “employer” as used in this specification is a reader/reviewer of a resume such as a recruiter, hiring manager, or a human resources professional. A “reader,” “reviewer,” and “employer” may be used interchangeably.

As can be seen in FIG. 3a, organizational tabs 11-16 are created by the claimed system. The tabs 11-16 contain prioritized information 17-24 from a prioritizer script. A “tab” is a visual representation of a file folder label—used to identify or describe the contents of such file folder. In the case of the subject matter disclosed herein, such a tab is not physical as in the case of a file folder, but is graphical—computer generated. Such a tab may describe the contents of a section of a resume or profile (or other sectioned website or document). The default tab of the preferred embodiment is the “Background” tab. The contents of the background section 30 are displayed (active) by default and include “Work Experience” and “Education” information. The user/reader can click with his mouse (or other input device) on the various tabs (such as “Skills” or “Media”) which will change the active contents 30 that are displayed on the right side of the resume.

The resume shown in FIG. 3b behaves similarly to the resume shown in FIG. 3a. The prioritized information hyperlinks (e.g., through the “more” link) the user to more in-depth information on specific sections of the resume.

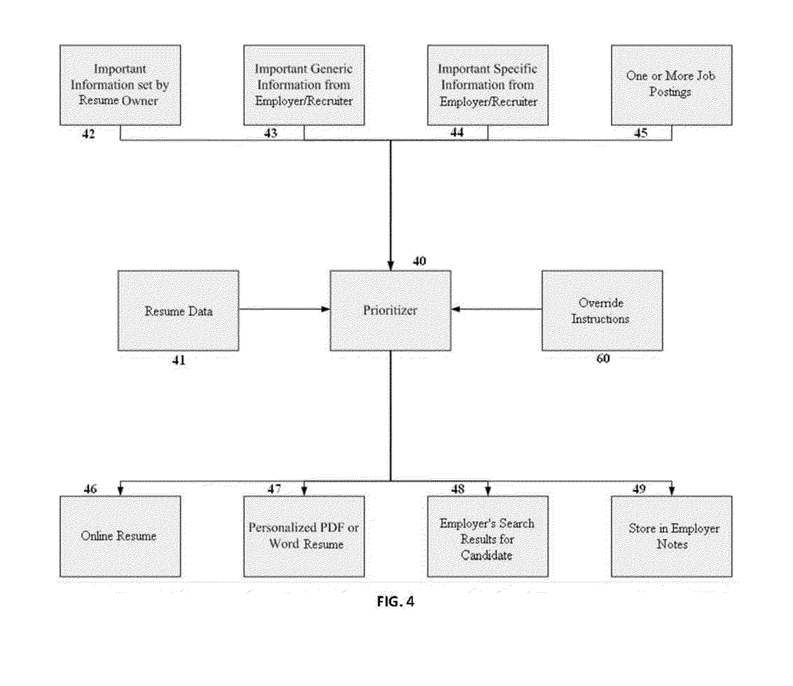

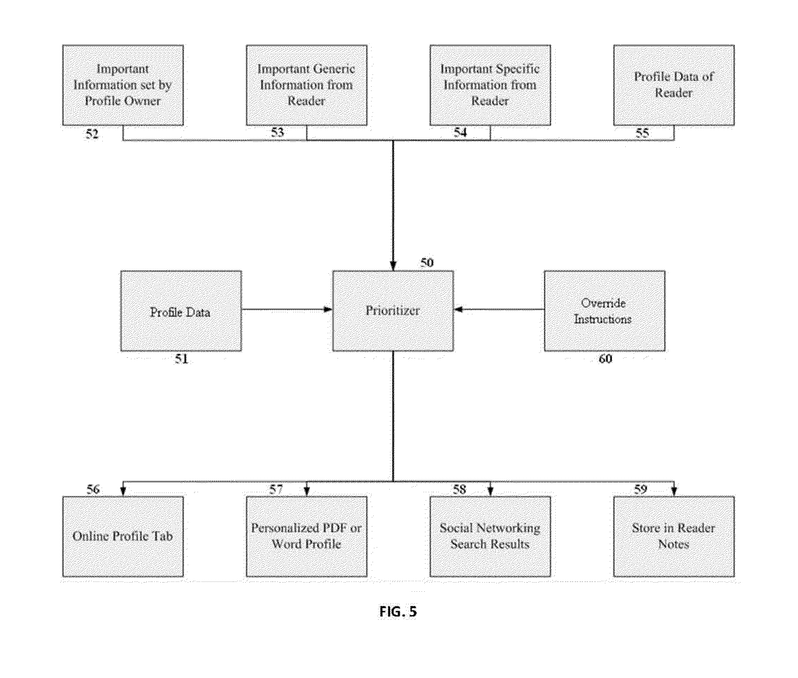

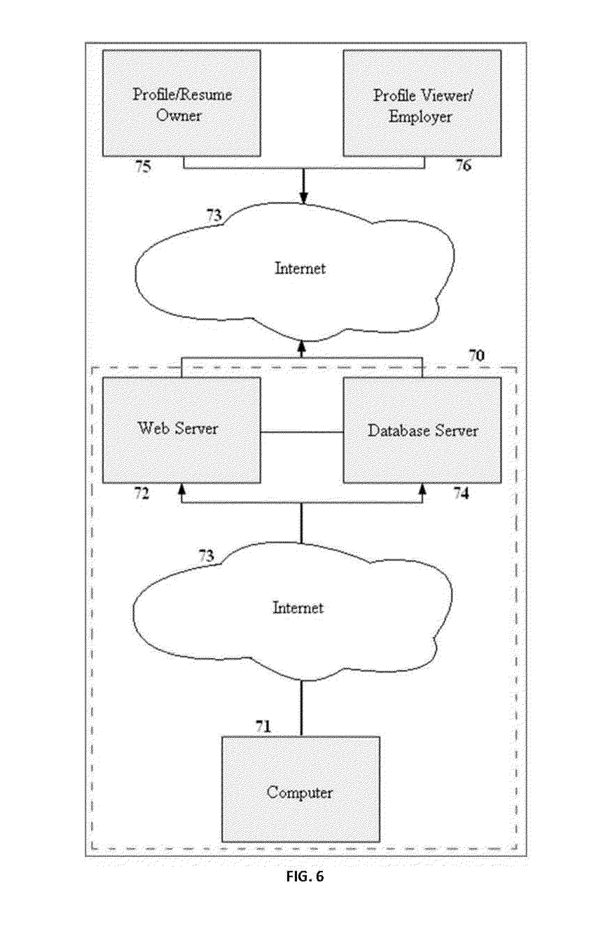

As shown in FIG. 4, the algorithm(s) in the prioritizer 40 behind the organizational tabs 11-16 take resume data 41 combined with at least one of:

(a) information deemed important by the resume owner 42;

The resume owner may either specify which information must be in the tabs or specify which information the resume owner prefers to be in the tabs. For example, the resume owner may require that it be shown that he attended Harvard Medical School or may prefer it to be shown that he can perform a particular medical procedure. Whether information is a must or simply a preference will be taken into consideration by the prioritizer 40.

(b) generic information deemed important by the employer 43;

The reader may specify in his account that in every search he performs, he prefers to see that a candidate attended a “top 10” university; has attained at least a bachelor's degree; or has a particular skill. This type of important information would be specified in the reader's search preferences so that it would not have to be entered for every search.

(c) specific information deemed important by the employer 44;

When performing a search for a particular candidate/resume/profile, the employer/reader may type in to such search keywords that he prefers to be in a particular resume/profile. The keywords entered in the search are specific information that the employer/reader is searching for—for a specific search (as opposed to information that is preferred to be in every search as in (b) above. and

(d) data contained in an employer's previously stored job post 45;

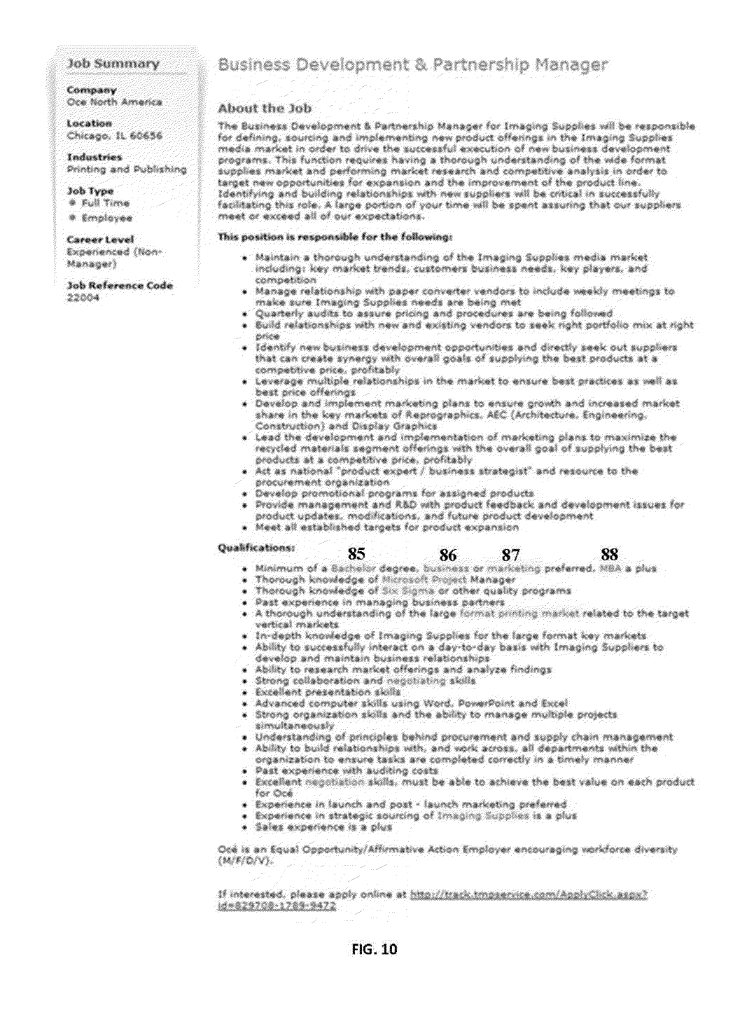

Important information may be determined manually or automatically from a job post. If an employer is searching for a particular candidate and has already posted a job for such candidate (such as that shown in FIG. 10), the employer may go to the particular job post and use that job post to find a candidate—whereby relevant words may be determined automatically from the resume and those words will be used automatically in a candidate/resume search. For job posts that are not generally field-based, a tool such as KEYWORD DENSITY & PROMINENCE 2.7 found at http://www.ranks.nl/tools/spider.html for analyzing webpages and generating metatags may be used for determining keywords. For example, such a webpage analyzer may determine that a particular word is important in a resume based on: formatting (i.e., bold or bulleted); location (i.e., first in a list of bullets); and/or the number of times the word or phrase is repeated. The important words selected by the webpage analyzer are then entered into a candidate/resume search. The two-step process (analyzing and searching) would seem seamless to the employer/user. For structured job posts, key fields such as selected skills or selected university could be prioritized.

((a), (b), (c) and (d) each a “prioritization instruction”) and uses prioritization rules to determine which prioritization instructions to follow and then display to the particular employer/reader as prioritized data (FIGS. 3a, 17-18, 19-21, and 22-24) in various electronic formats (FIG. 4, 46-49). Prioritized resume data can be inserted into an online resume 46 (as shown in FIG. 3a), a personalized PDF or Word resume 47, an employer's (or other searcher's) search results 48 when searching for a candidate, or in an employer's personalized notes 49 regarding a stored document or profile.

An “electronic resume” means a webpage for displaying an html resume such as those displayed on Monster™, CareerBuilder™, HotJobs™, or VisualCV or an electronic document such as Microsoft™ Word™ or Adobe™ PDFTM file that is generated by or through use of a website or software on or linked to a website.

An “electronic profile” means a computerized profile of a person on a website such as Facebook™, Linkedin™, or MySpace™ or a computerized profile of a thing such as a listing of an electronic commerce item (i.e., a product listing on Amazon.com). Any type of electronic file(s) maybe used to create electronic resumes and electronic profiles including but not limited to html, xml, pdf, doc, txt, rtf, php, asp, or combinations thereof.

As shown in FIG. 5, the prioritizer script 50 can also be used in a social media profile context to organize profile data for a particular reader. In this case, the prioritizer script takes profile data 51 combined with at least one of:
(a) information deemed important by the profile owner (of the profile the reader is reading) 52;
(b) generic information deemed important by the reader 53;
(c) specific information deemed important by the reader 54; and
(d) data contained in the reader's profile 55;

((a), (b), (c) and (d) also “prioritization instructions”) and produces prioritized data for a selected profile.

To “prioritize” means to rank higher in importance (i.e., for a particular reader). As shown in FIGS. 3 and 4, the prioritizer 40, 50 may contain code that ranks information deemed important by the employer/reader 43-45, 53-55 higher than information deemed important by the resume/profile owner 42, 43 or vice versa. The document owner or reader may provide override instructions 60 to override the default prioritization algorithm in the prioritizer 60. If an employer specifies multiple keywords or preferences—there may not be enough space/area in the tabs 11-16 (or other data container) to display the both the employer's/reader's search preferences as well as the resume/profile owner's preferences. In this case, the prioritizer may not allow the document owner to override the default settings.

Any data can be prioritized. A “data item” means any data or information (whether text, image, video) on a profile, resume, or other document such as a skill, qualification, interest, media file, link, or thumbnail.

A “table” means an arrangement of text, images, or videos, or combinations therein, usually in one or more columns, to exhibit a set of facts or relations in a definite, compact, and comprehensive form.

A “field” means an area in a webpage or electronic document into which data is inserted. The area may be in a fixed location and may have fixed formatting.

A “frame” means rectangular segment within a browser's window that can be scrolled independently of other such segments.

A “list” mans a series of words, images, videos, hyperlinks, or other items written, printed, or imagined one after the other. Lists can be bulleted, in outline form, or neither.

A “webpage” means a document on the World Wide Web often hyperlinked to other documents on the web and normally accessed by using a browser.

A “reader preference” is a data item that the reader prefers to see in a document or webpage. A “reader” in a resume context is an employer, recruiter, hiring manager, or other human resources professional. A “reader” in a social media context is a social contact, potential social contact, friend, business contact or other potentially related individual.

A “reader search” is a search into a search engine by a reader (employer or social contact).

A “search term” is text or other data entered by a user into a search engine.

A “document owner” is the owner of the particular electronic document or online resume or profile.

A “prioritization instruction” is an instruction by way of a direction, allowance, or disallowance of a data item to be included in prioritization of the data items by the document owner. The document owner may require that a particular data item be included in the prioritized list of data items for a particular reader or all readers of the document. The document owner may also permit or prevent a particular data item to be included in the prioritization of data items. The document owner or the reader may specify data items that are either required or preferred. Whether or not these required or preferred data items appear in the electronic documents or webpages in the database affects the search results of a reader search. If a required data item is found in an electronic resume or other document in the database, this would be given more weight in the search results versus a preferred data item. Required data items would preferably be displayed higher than preferred data items within the data container.

A “prioritization rule” is a mathematical rule set by the site owner or determined automatically (by the prioritizer based on presence or absence of prioritization instructions) to determine which prioritization instructions take priority over other prioritization instructions.

The architecture of the computer system 70 in accordance with one embodiment of the subject matter disclosed herein will now be described in further detail. The computer system 70 includes: (1) a first computer 71; (2) a web server 72 that contains the prioritizer 40,50 and is accessible by users (resume owners, profile owners, employers, profile readers) over the internet 73; and (3) a database server 74 (also accessible over the internet) that stores resume/profile data 41,51. Profile/Resume Owners 75 can access the web server 72 and update the database server 74. Profile Viewers/Employers 76 access the web server 72 and database server 74 to view profiles/resumes. The first computer 71 also includes application specific software modules that implement functions of the computer system 70 in conjunction with the web server 72 and the database server 74. The web server 72, the database server 74, and the software modules may be contained within one computer or may be installed in separate networked computers that together comprise the first computer 71. In a preferred embodiment, the operating system used for the computer or computers comprising the first computer is Red Hat's Enterprise Linux operating system; the web server 72 is implemented using Apache's HTTP Server (apache), version 2.0 or higher; and the database server 74 is implemented using Sun's MySQL Server (MySQL), version 5 or higher. The web server 72 includes application-specific HTML-embedded scripting language (possibly coded using PHP: Hypertext Preprocessor (PHP)) to implement functionality of systems and methods of the subject matter disclosed herein.

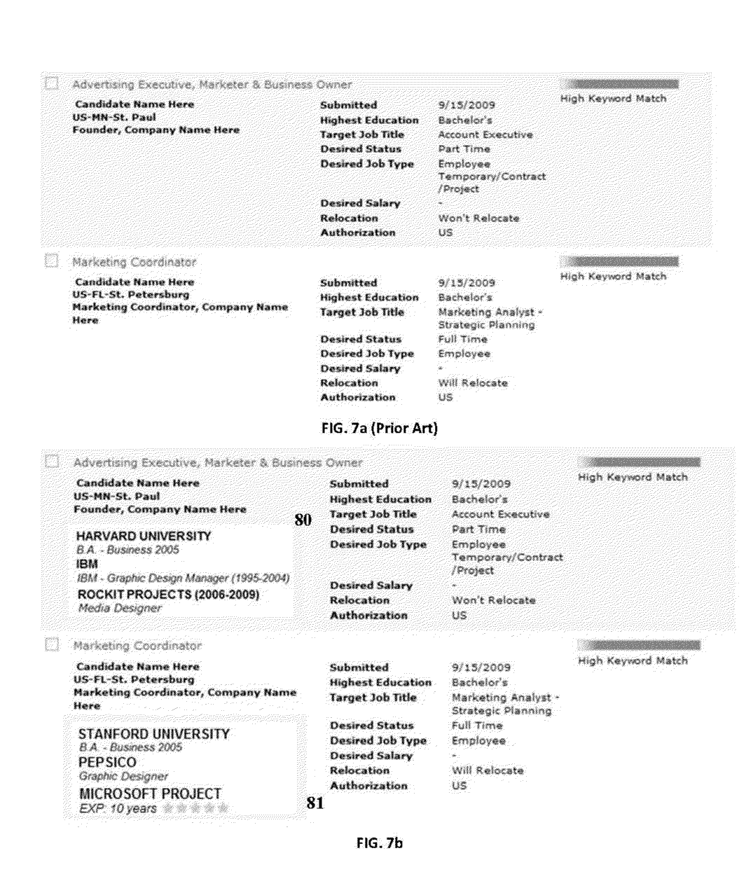

FIG. 7a shows a prior art listing of search results returned from a candidate search on a job website. FIG. 7b shows an embodiment of the subject matter disclosed herein whereby two additional summarization elements 80, 81 were added to search results to improve the employer's review of those search results.

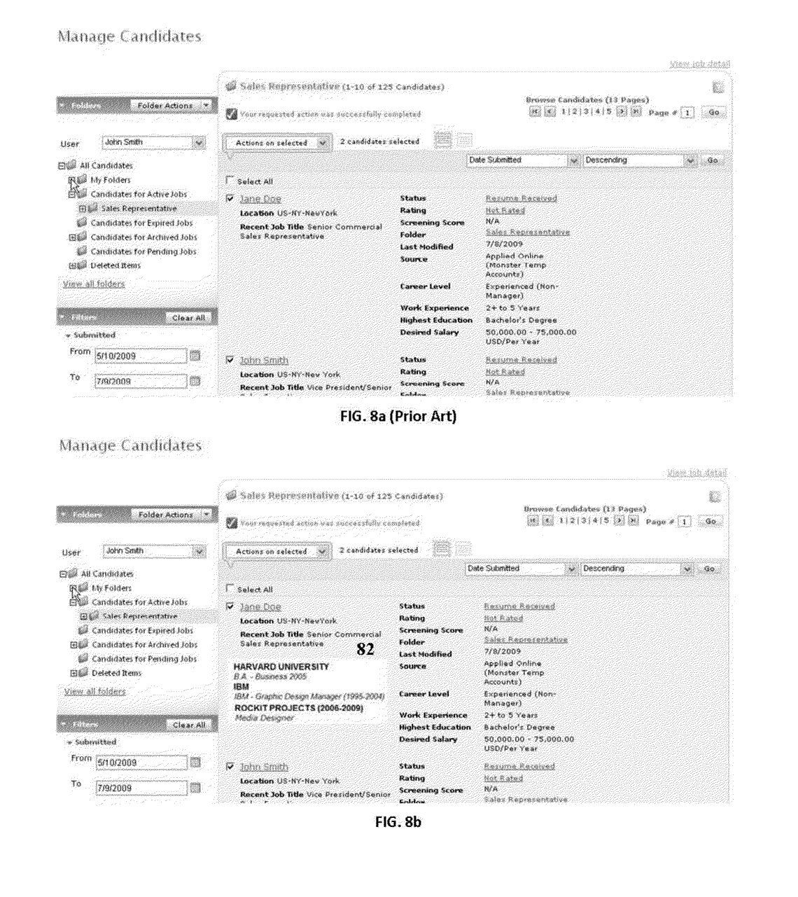

FIG. 8a shows a prior art listing of saved candidates stored in an employer's account on a job website. FIG. 8b shows an embodiment of the subject matter disclosed herein whereby an additional summarization element 82 was added to the saved candidate listings to improve the employer's review of those candidate listings.

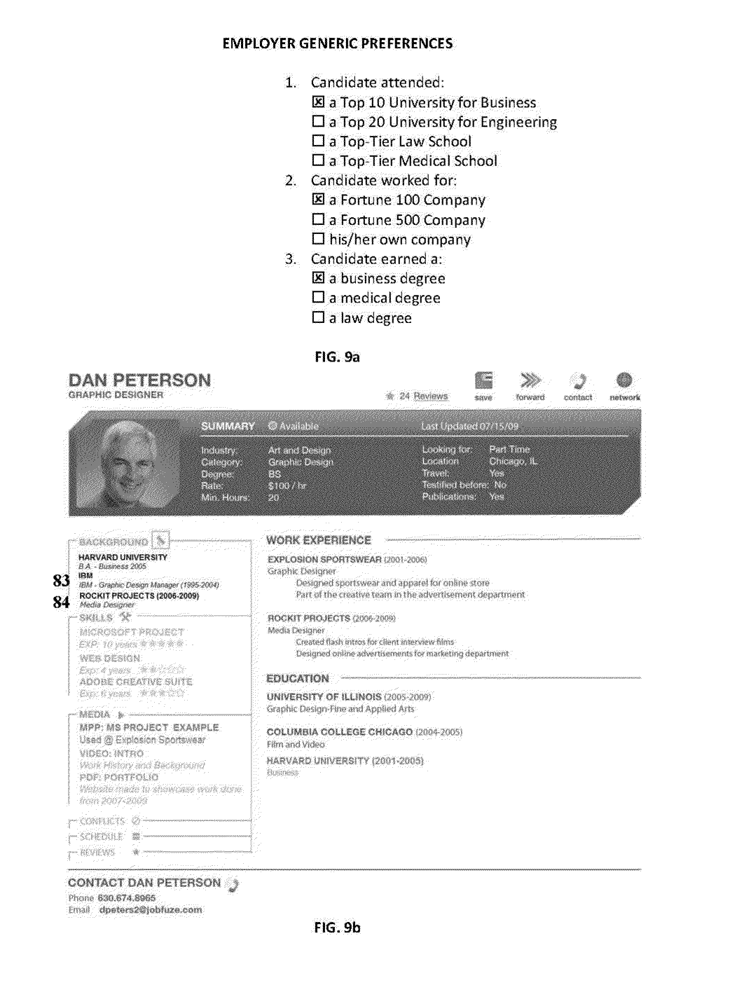

FIG. 9a shows a graphical user interface that allows an employer to be able to select general preferences that they would like to see in every candidate returned in their search results. FIG. 9b shows a resume returned after the prioritizer searching the database with those preferences. Because the employer selected in his general preferences that every candidate the system returned to 1) have attended “a Top 10 University for Business,” 2) have worked for “a Fortune 100 Company,” and 3) have earned a business degree, the system returned a resume of a candidate with those qualifications—The candidate 1) attended Harvard University 83, 2) worked for IBM 84, and 3) earned a bachelor's degree in business 83.

Using the subject matter disclosed herein, an employer is able to select a previously stored job post as shown in FIG. 10 to generate a list of potential candidates. The employer would not need to do a manual keyword search for a candidate. When the previously stored job post is selected to find applicable candidates, relevant words 85-88 may be determined by a webpage analyzer and inserted automatically into a search. The prioritizer FIG. 4 40 would then take the words selected by the webpage analyzer from the stored job post 45 to prioritize resume data 41 contained in the resume.

A “job post” is an online advertisement of an available job opening—suggesting a request for resumes from qualified candidates. Job posts can be found in online newspapers, magazines, trade group websites, company websites, and on job search websites such as Monster™, CareerBuilder™, or HotJobs™.

In accordance with the subject matter disclosed herein, the display of resumes contained in the resume database dynamically updated based on 1) changes in resume data, 2) change in search terms, 3) changes in employer preferences, 4) changes in candidate display preferences, and 5) changes in analyzed job posts.

The subject matter disclosed herein introduces a new interactive resume—additional links are created in the resume. These additional links allows the resume to become a data source for candidates. Job search sites are able to record the links that are selected by an employer and record the time those links were selected. This allows the job search sites to calculate the time spent interacting with various sections of the resume. This data can be given back to the resume owner or can be provided to an employer to show that a particular job candidate is popular and might be difficult to hire.

The subject matter disclosed herein is also able to be used in an online shopping context—when searching for a product for the user or for a second person (i.e., a gift).

1. An online shopping website as Amazon.com could take information contained in a user's social networking profile to display optimized product data to the user. The user would login to their social networking profile (i.e., Facebook) to purchase products from the online shopping website (i.e., Amazon.com). The social networking profile would contain preferences of the user applicable to various shopping websites. After logging into Facebook, the user would be presented with a link to Amazon.com that would send their preferences to Amazon.com. The user would then search for product on Amazon.com. Amazon.com would return applicable search results, preferably sorted by relevance to the search terms and to the interests of the user. When a product is selected by the user, information about the product that matches the interests of the user would be highlighted or located in a prime location on the webpage (e.g., in a tab or in a box at the top of the product webpage) so that the user can see why the product was returned by the search engine to be of interest to the user.

2. A first person can post things they like or are interested in on the internet on their social networking profile. A second person searching for a gift for the first person could use the things they are interested in to search for a product that the second person could give the first person as a gift. The returned products (potential gifts) could highlight or prioritize terms relevant to the interests of the first person. In this sense, generic preferences might include product limitations such as price limitations such as “Under $25” or category limitations such as “Electronics”.

Although the subject matter disclosed herein is implemented on a web server, other embodiments could be over an intranet, a networked group of computers, or on a single computer to aid in display of organized data. While a specific embodiment of the subject matter disclosed herein has been shown and described, it will be apparent that certain changes and modifications may be practiced that are within the scope of the appended claims.

What is claimed is:

1. One or more computer readable media containing computer-executable instructions that, when executed on one or more computers performs the following steps:
a. prioritizing one or more data items in a priority order; and
b. displaying at least one of the one or more data items in a data container in at least one of an electronic resume and an electronic profile in the priority order.

2. The instructions of claim 1 wherein the electronic resume is a webpage.

3. The instructions of claim 2 wherein the data container is a tab, a table, a field, a frame, a list, an index, or a webpage.

4. The instructions of claim 1 wherein the electronic resume is an electronic document.

5. The instructions of claim 4 wherein the data container is a tab, a table, a field, a frame, a list, an index, or a textbox.

6. The instructions of claim 1 wherein the one or more data items are at least partially prioritized based on at least one of:
a. a reader preference;
b. an employer preference;
c. a search term in an reader search;
d. a search term in an employer search;
e. a prioritization instruction from a document owner;
f. a prioritization instruction from a resume owner; and
g. a matching data item in a job post.

7. The instructions of claim 6 wherein the one or more job posts are selected by
a. the employer; or
b. at least one of the one or more computers.

8. The instructions of claim 1 further performing the step of updating the data container.

9. The instructions of claim 8 wherein the updating step is based on a change to at least one of
a. a reader preference;
b. an employer preference;
c. a search term in a reader search;
d. a search term in an employer search;
e. a prioritization instruction from a document owner;
f. a prioritization instruction from a resume owner; and
g. a matching data item in a job post.

10. The instructions of claim 1 wherein the one or more data items comprise at least one of:
a. a skill;
b. a qualification;
c. an interest;
d. a media file;
e. a link; and
f. a thumbnail.

11. A computer readable medium with a computer program stored thereon, wherein the computer program comprises:
a. one or more prioritization instructions to prioritize one or more data items in a priority order; and
b. display instructions to display at least one of the one or more data items in a data container in at least one of an electronic resume and an electronic profile in the priority order.

12. The computer program of claim 11 wherein the electronic resume is a webpage.

13. The computer program of claim 12 wherein the data container is a tab, a table, a field, a frame, an index, or a webpage.

14. The computer program of claim 11 wherein the electronic resume is an electronic document

15. The computer program of claim 14 wherein the data container is a tab, a table, a field, a frame, an index, or a textbox.

16. The computer program of claim 11 wherein the one or more data items are at least partially prioritized based on at least one of:
a. a reader preference;
b. a employer preference;
c. a search term in an reader search;
d. a search term in an employer search;
e. a prioritization instruction from a document owner;
f. a prioritization instruction from a resume owner; and
g. a matching data item in a job post.

17. The computer program of claim 16 wherein the one or more job posts are selected by
a. the employer; or
b. one of the one or more computers.

18. The computer program of claim 11 further performing the step of updating the data container.

19. The computer program of claim 18 wherein the updating step is based on a change to at least one of
a. a reader preference;
b. an employer preference;
c. a search term in an reader search;
d. a search term in an employer search;
e. a prioritization instruction from a document owner;
f. a prioritization instruction from a resume owner; and
g. a matching data item in a job post.
h.

20. The computer program of claim 11 wherein the one or more data items comprise at least one of:
a. a skill;
b. a qualification;
c. an interest;
d. a media file;
e. a link; and
f. a thumbnail.
